(19) United States
(12) Patent Application Publication
(10) Pub. No.: US 2017/0202181 A1
(43) Pub. Date: Jul. 20, 2017

(54) Cat Scratcher Device and Method of Assembly

(71) Applicant: Worldwise, Inc., Novato, CA (US)

(72) Inventors: Mark Hartelius, Chicago, IL (US); Michael Risso, Novato, CA (US)

(21) Appl. No.: 14/995,818

(22) Filed: Jan. 14, 2016

(51) Int. Cl. A01K 15/02

(52) U.S. Cl. CPC A01K 15/024

(57) ABSTRACT

A cat scratcher device fabricated from a kit of parts as well as a method for its assembly. The device includes a base and cylinder both having surfaces covered by cat scratching material. The cylinder has a first end and a second end, the first end abutting the base and the second end extending distally therefrom and an end cap sized to fit over the second end of the cylinder which is provided with an opening for receiving a ribbed cable strap fitting. A ribbed cable strap is included in the kit, the first end of which is secured to the end cap and the second end of which passes along the longitudinal axis of the cylinder and through a centrally located disk positioned at the first end of the cylinder and through an opening in the base and secured thereto through the use of a pawl such that when the ribbed cable strap is pulled through the pawl, it is tensioned to secure the cylinder to the base.

### RELATED APPLICATION

The present application is a continuation in part of U.S. application Ser. No. 14/939,737, filed on Nov. 12, 2015.

### TECHNICAL FIELD

The present invention involved a cat scratching device for providing cat scratching surfaces of the type used by domestic cats. The device can be shipped and warehoused as a kit of individual parts and which is designed to be easily assembled by a pet owner.

### BACKGROUND OF THE INVENTION

It is well recognized that domestic cats crave scratching, as part of their natural instinctive character. If a dedicated scratching surface is not provided, domestic cats will generally satisfy their need to scratch by turning to furniture, curtains and other articles which may be substantially damaged as a consequence. Often times, pet cats will not only climb over furniture, specially upholster chairs and sofas, but will use such furniture and carpeting to condition their claws through deliberate repeated clawing, pulling and tearing actions specifically with their forepaws. As noted, this clawing activity appears to be an irresistible natural impulse for cats and can be the source great aggravation to the pet owner. As such, a dedicated scratcher is a necessity for any cat owner.

A number of vendors of pet and pet related products have offered dedicated scratching posts and surfaces in order to ameliorate this problem. Scratching posts are generally sold as fully assembled constructs thus obviating the need to assemble the scratcher from a kit of parts. Vendors of such products generally opt to warehouse and sell assembled scratchers as many pet owners do not have ready access to the tools necessary for assembly.

There are certainly drawbacks in shipping and promoting for sale fully assembled scratchers. Among them are shipping costs which represent a significant fraction of the products' overall price. It has become increasingly common to manufacture such products offshore where labor costs are less than those in this country. This is particularly true as it pertains to the manufacture of non-complex or relatively to end products which can be assembled by relatively unskilled labor. However, as manufacturing has shifted offshore, shipping costs have become an increasingly more significant percentage of product pricing.

Typically, manufactured goods produced in Asia are imported into the United States on commercial vessels. These goods are not only manufactured but packaged at Asian factories and multiple units placed within cardboard containers or otherwise bundled in groups for placement within cargo containers which are, in turn, stacked atop one another in appropriately configured vessels. The shipping cost per item is dictated by the number of such items which can be placed within said shipping containers as the cost per transoceanic passage substantially remains fixed.

Certain items, such as televisions, stereos, computers and semiconductor chips can be conveniently stacked within rectangular shipping containers as such products are usually enclosed within square or rectangular boxes which optimally stack in such containers. However, self-supporting scratchers, if shipped assembled, cannot be densely packed within transoceanic shipping containers and thus, the cost of shipping such products can be inordinately high. In addition, once such products are received by a retailer, warehousing them can be a challenge as a fully assembled scratcher occupies more warehousing space than is justified by the price of the product. This also pertains to the inordinately excessive shelf space that such a product would occupy noting that inefficient shelving negatively impacts profitability.

It is thus an object to the present invention to provide a scratcher device which can be shipped and warehoused in kit form.

It is yet a further object of the present invention to provide a scratcher device which can be purchased by a pet owner in kit form and easily assembled without the use of tools or by engaging in complex assembly steps.

These and further objects be more readily apparent when considering the following disclosure and appended claims.

### SUMMARY OF THE INVENTION

A cat scratcher device comprising a base, said base having an outer surface substantially covered by a cat scratching material, a substantially cylindrical member also having an outer surface substantially covered by a cat scratching material, said substantially cylindrical member having a first end and a second end and a cylindrical longitudinal axis, said first end abutting said base and said second end extending distally therefrom, an end cap sized to substantially cover said second end of said substantially cylindrical member, said end cap having an end cap opening aligned along said cylindrical longitudinal axis, a ribbed cable strap, a first end of which terminates in a cable strap fitting, said cable strap fitting being sized to be received by said end cap opening, a stabilizer disk positioned between said first end of said substantially cylindrical member and said base and having a centrally located disk opening therein, said base having a base opening aligned with said disk opening along said cylindrical longitudinal axis and each sized to allow said ribbed cable strap to passed there through, a pawl fitted within said base opening sized to receive said ribbed cable strap such that when said ribbed cable strap is pulled through said pawl, said ribbed cable strap is tensioned along said cylindrical longitudinal axis to secure said substantially cylindrical member to said base.

A cat scratcher device comprising a base, said base having an outer surface substantially covered by a cat scratching material, a substantially cylindrical member also having an outer surface substantially covered by a cat scratching material, said substantially cylindrical member having a first end and a second end and a cylindrical longitudinal axis, said first end abutting base and said second end extending distally therefrom, an end cap comprising a disk sized to substantially cover said second end of said substantially cylindrical member, said end cap having a geometric center aligned along said cylindrical longitudinal axis, a ribbed cable strap extending from the geometric center of said end cap, a disk positioned between said first end of said substantially cylindrical member and said base and having a centrally located disk opening therein, said base having a base opening aligned with said disk opening along said cylindrical longitudinal axis and each sized to allow said ribbed cable strap to passed there through, a pawl fitted within said base opening sized to receive said ribbed cable strap such that when said ribbed cable strap is pulled through said pawl, said ribbed cable strap is tensioned along said cylindrical longitudinal axis to secure said substantially cylindrical member to said base.

A method of assembling a cat scratcher device, said cat scratcher device comprising a base, said base having an outer surface substantially covered by a cat scratching material, a substantially cylindrical member also having an outer surface substantially covered by a cat scratching material, said substantially cylindrical member having a first end and a second end and a cylindrical longitudinal axis, said first end abutting said base and said second end extending distally therefrom, an end cap sized to substantially cover said second end of said substantially cylindrical member, said end cap having an end cap opening aligned along said cylindrical longitudinal axis, a ribbed cable strap, a first end of which terminates in a cable strap fitting, said cable strap fitting being sized to be received by said end cap opening, a stabilizer disk positioned between said first end of said substantially cylindrical member and said base and having a centrally located disk opening therein, said base having a base opening aligned with said disk opening along said cylindrical longitudinal axis and each sized to allow said ribbed cable strap to passed there through, a pawl sized for fitting within said base opening and sized to receive said ribbed cable strap, said method comprising applying said end cap to said second end of said substantially cylindrical member, passing said ribbed cable strap through said end cap opening such that said cable strap fitting seats within said end cap opening, pulling said ribbed cable strap along said cylindrical longitudinal axis, passing said ribbed cable strap through said centrally located disk opening and through said base opening, pulling said ribbed cable strap through said pawl to tension said ribbed cable strap and to secure said substantially cylindrical member to said base.

### BRIEF DESCRIPTION OF THE DRAWINGS

FIG. 1 is a perspective view of a kit of parts that represent the present invention.

FIG. 2 is a perspective expanded view of the cat scratcher device constructed from the kit of parts of FIG. 1.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features the invention that will described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward” “left” and “right” refer to directions to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

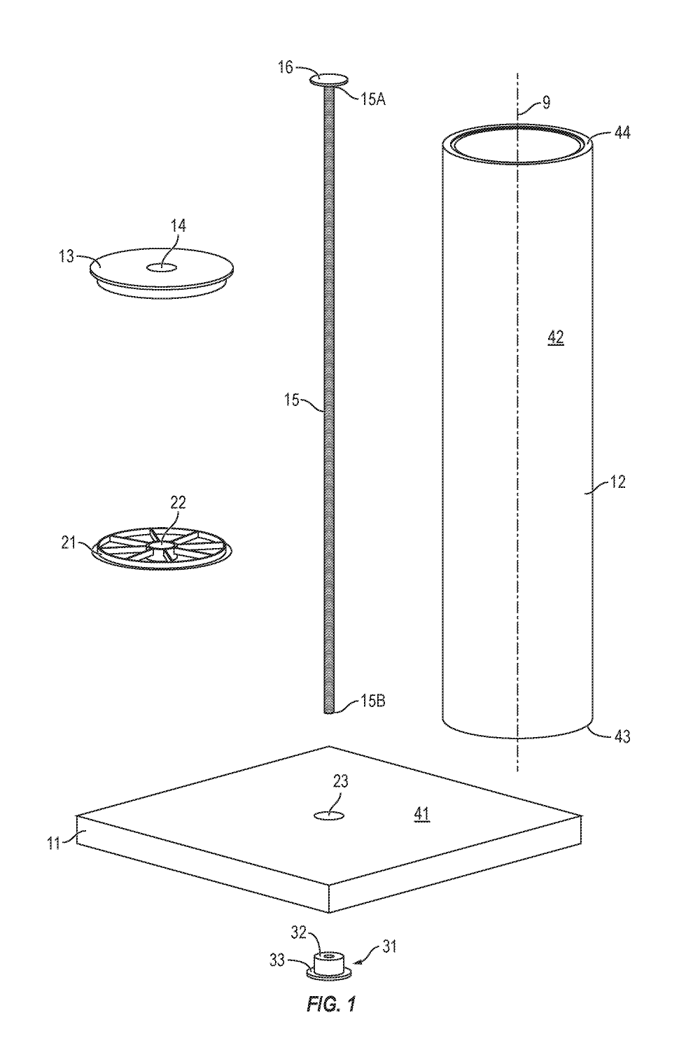

Turning to FIG. 1, a kit of parts is shown for constructing the cat scratcher device of the present invention. The kit is provided with base having an outer surface substantially covered by cat scratching material 41. The device also includes substantially cylindrical member 12 also having an outer surface substantially covered by cat scratching material 42. The cat scratching material can be one of any variety of well-known materials employed for this purpose such as carpet, sisal, and the like.

Substantially cylindrical member 12 is characterized as having a first end 43, second end 44 and longitudinal axis 9, first end 43 abutting base 11 and second end 44 extending distally therefrom when assembled. An end cap 13 is sized to substantially cover second end 44 of substantially cylindrical member 12, end cap 13, in a first embodiment, having opening 14 centrally located therein and aligned with longitudinal axis 9 when kit 10 is fully assembled.

As a first embodiment ribbed cable strap 15 is characterized as having first end 15A and second end 15B and cable strap fitting 16 located at first end 15A. Cable strap fitting 16 is sized to be received by end cap opening 14 allowing ribbed cable strap 15 to passed there through but not cable strap fitting 16. As such, during assembly, cable strap 15 will be drawn through end cap opening 14 pulling cable strap fitting 16 against end cap 13 without cable strap fitting 16 passing there through.

To assist in stabilizing substantially cylindrical member 12 against base 11, the kit also includes stabilizer disk 21 which, upon assembly, is positioned between first end 43 of substantially cylindrical member 12 and the top surface of base 11. Stabilizer disk 21 is characterized as having a centrally located disk opening 22. Base 11 is also provided with an opening, being base opening 23 which, upon assembly, aligns with disk opening 22 along cylindrical longitudinal axis 9. Disk opening 22 and base opening 23 are sized to allow ribbed cable strap 15 to passed there through. Pawl 31 is sized to enable it to be fitted with in base opening 23 by appropriately sizing pawl body portion 32 slightly smaller in diameter than base opening 23 while expanded pawl end 33 is larger in diameter than base opening 23 to prevent pawl 31 from passing through base opening 23 upon being tensioned as described below.

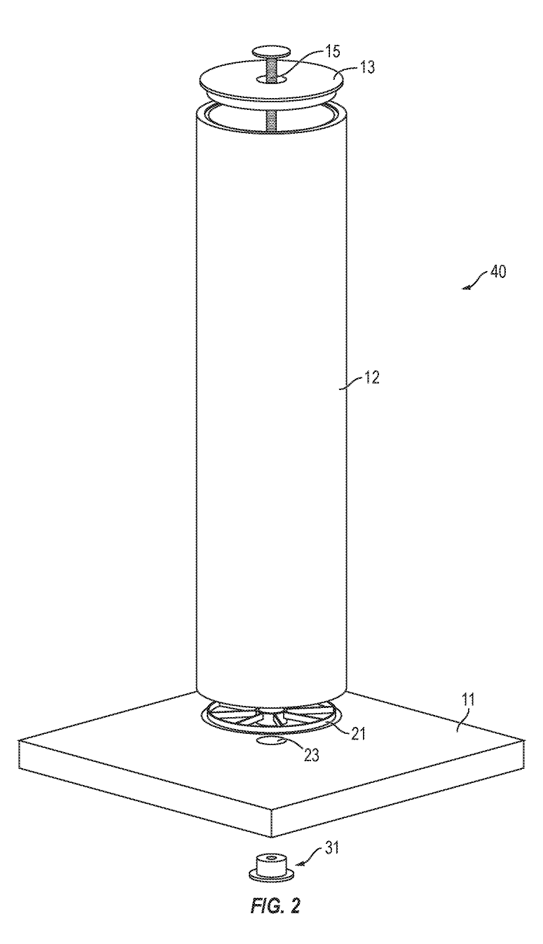

In assembling the kit creating scratcher device 40 (FIG. 2), end cap 13 is fitted over second end 44 of substantially cylindrical member 12 aligning end cap opening 14 with cylindrical longitudinal axis 9. In one embodiment, ribbed cable strap 15 can be molded into end cap 13 as a unitary piece. However, in the embodiment shown herein, ribbed cable strap 15 is drawn through end cap opening 14 and pulled along cylindrical longitudinal axis 9 until cable strap fitting 16 abuts end cap opening 14 preventing further movement. Stabilizer disk 21 is placed atop base 11 aligning stabilizer disk opening 22 with base opening 23 also along cylindrical longitudinal axis 9. Pawl 31 is inserted from the bottom of base 11 through base opening 23 until expanded pawl end 33 abuts the bottom surface of base 11. Thereupon, ribbed cable strap 15 is drawn through base 11 and through pawl 31 and is tensioned along cylindrical longitudinal axis 9 to tension ribbed cable strap 15 and to secure substantially cylindrical member 12 to base 11.

In summary, the present invention is directed to a cat scratcher device composed of a kit of parts which, prior to assembly, can be made to fit compactly within a relatively small container for shipment and storage and yet the kit of parts can be assembled by any pet owner without tools and without any complex assembly steps.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

What is claimed is:

1. A cat scratcher device comprising a base, said base having an outer surface substantially covered by a cat scratching material, a substantially cylindrical member also having an outer surface substantially covered by a cat scratching material, said substantially cylindrical member having a first end and a second end and a cylindrical longitudinal axis, said first end abutting said base and said second end extending distally therefrom, an end cap sized to substantially cover said second end of said substantially cylindrical member, said end cap having an end cap opening aligned along said cylindrical longitudinal axis, a ribbed cable strap, a first end of which terminates in a cable strap fitting, said cable strap fining being sized to be received by said end cap opening, a stabilizer disk positioned between said first end of said substantially cylindrical member and said base and having a centrally located disk opening therein, said base having a base opening aligned with said disk opening along said cylindrical longitudinal axis and each sized to allow said ribbed cable strap to passed there through, a pawl fitted within said base opening sized to receive said ribbed cable strap such that when said ribbed cable strap is pulled through said pawl, said ribbed cable strap is tensioned along said cylindrical longitudinal axis to secure said substantially cylindrical member to said base.

2. A cat scratcher device comprising a base, said base having an outer surface substantially covered by a cat scratching material, a substantially cylindrical member also having an outer surface substantially covered by a cat scratching material, said substantially cylindrical member having a fist end and a second end and a cylindrical longitudinal axis, said first end abutting said base and said second end extending distally therefrom, an end cap comprising a disk sized to substantially cover said second end of said substantially cylindrical member, said end cap having a geometric center aligned along said cylindrical longitudinal axis, a ribbed cable strap extending from the geometric center of said end cap, a disk positioned between said first end of said substantially cylindrical member and said base and having a centrally located disk opening therein, said base having a base opening aligned with said disk opening along said cylindrical longitudinal axis and each sized to allow said ribbed cable strap to passed there through, a pawl fitted within said base opening sized to receive said ribbed cable strap such that when said ribbed cable strap is pulled through said pawl, said ribbed cable strap is tensioned along said cylindrical longitudinal axis to secure said substantially cylindrical member to said base.

3. A method of assembling a cat scratcher device, said cat scratcher comprising a base, said base having an outer surface substantially covered by a cat scratching material, a substantially cylindrical member also having an outer surface substantially covered by a cat scratching material, said substantially cylindrical member having a first end and a second end and a cylindrical longitudinal axis, said first end abutting said base and said second end extending distally therefrom, an end cap sized to substantially cover said second end said substantially cylindrical member, said end cap having an end cap opening aligned along said cylindrical longitudinal axis, a ribbed cable strap, a first end of which terminates in a cable strap fitting, said cable strap fitting being sized to be received by said end cap opening, a stabilizer disk positioned between said first end of said substantially cylindrical member said base and having a centrally located disk opening therein, said base having a base opening aligned with said disk opening along said cylindrical longitudinal axis and each sized to allow said ribbed cable strap to passed there through, a pawl sized for fitting within said base opening and sized to receive said ribbed cable strap, said method comprising applying said end cap to said second end of said substantially cylindrical member, passing said ribbed cable strap through said end cap opening such that said cable strap fitting seats within said end cap opening, pulling said ribbed cable strap along said cylindrical longitudinal axis, passing said ribbed cable strap through said centrally located disk opening and through said base opening, pulling said ribbed cable strap through said pawl to tension said ribbed cable strap and to secure said substantially cylindrical member to said base.
